(19) United States
(12) Patent Application Publication
(10) Pub. No.: US 2012/0102020 A1
(43) Pub. Date: Apr. 26, 2012

(54) Generating Search Result Listing with Anchor Text Based Description of Website Corresponding to Search Result

(76) Inventor: Mark Pearson, Berkeley, CA (US)

(21) Appl. No.: 13/342,915

(22) Filed: Jan. 3, 2012

Related U.S. Application Data
(63) Continuation of application No. 10/729,449, filed on Dec. 4, 2003, now abandoned.

(51) Int. Cl. G06F 17/30

(52) U.S. Cl. 707/709; 707/E17.108

(57) ABSTRACT

An apparatus and method is described that generates a description of a website using data from secondary sources, meaning sources other than the website itself. Relevant information is identified, within anchor text of links in the content of these secondary sources, and analyzed. Based on this analysis, a description of the website is generated.

### RELATED APPLICATION

This application is continuation of U.S. application Ser. No. 10/729,449, filed Dec. 4, 2003, which is hereby incorporated by reference herein in its entirety.

### BACKGROUND

1. Technical Field

The present invention relates generally to search engine technology, and more particularly, to a device and method for responding to a search query by generating a list of search results, a respective search result including a link to a website and a description of the website.

2. Background of the Invention

Internet search engines allow a user to more efficiently locate desired websites on the Internet. Typically, in response to a search query, a search engine provides a user search results containing a list of returned websites. The search engine also provides a brief description, proximate to a corresponding hyperlink (hereinafter “link”), of each of the returned websites. Stated another way, the search engine generates a list of search results, which includes for each respective search result, a link having a URL and descriptive text that is distinct from the URL and that is displayed proximate the link. Providing search results in this format allows the user to quickly review each website description and visit a particular website on this list by simply clicking on the link pointing to the website. These descriptions are an integral component of the search results format because an accurate description allows a user to quickly decide whether to view the described website.

Typically, search engines obtain a description of a particular website from data derived from the website itself. To obtain this description of the particular website, search engines require that the particular website had been previously processed, by a device such as a web crawler, so that data is available on which the description can be derived. A web crawler copies and processes website data, including content on the site itself, and creates entries within an index corresponding to the processed data. Once a website has been crawled, the website's content and characteristics are copied and stored in a storage device. However, if the website had not been crawled or otherwise processed, this stored data would be non-existent and a description of the website cannot be generated.

As the number of new websites on the Internet rapidly expands, crawling and maintaining current data for these sites becomes increasingly difficult. Oftentimes, a search engine may return a website, relevant to a search query, prior to the website having been crawled. This uncrawled website may be identified as relevant based on links and descriptive text, located on previously crawled websites, which refer to the uncrawled website. In such an instance, as described above, the search engine could only provide the user a link to the uncrawled website without a description. This failure to provide a description of the uncrawled website to the user reduces the quality of the search report and places greater burden on the user to identify desired websites in search results.

Accordingly, it is desirable to generate a description of a website using data derived from sources other than the website itself.

### SUMMARY OF DISCLOSED EMBODIMENTS

In accordance with some embodiments, a search engine generates a description of a website by using data derived from a secondary source(s). This data, although not directly derived from the website, may nevertheless provide relevant information about the website. For example, a secondary source website may have a link pointing to an uncrawled website. Data associated with that link may be identified, analyzed and used to generate a description of the uncrawled website. Thus, a description of the uncrawled website can be independently generated without having directly accessed the uncrawled website.

Information relevant to the uncrawled website is identified within the volume of processed data produced by web crawlers and derived from secondary sources. Selection criteria are applied to identify this relevant information found within this processed data. These selection criteria may include factors such as the location of information on a secondary source website, the type of information, the content in the information, and characteristics of the information. These criteria parse relevant information from this volume of processed data and enable a description to be generated based on this relevant information.

A secondary source website may contain multiple links pointing to numerous different websites. Assuming that one of these links points to the uncrawled website, data associated with this particular link may be identified as information relevant to the uncrawled website. For example, anchor text, on with this link, may be identified as relevant merely by its association with this link and its position on the link.

The relevant information is analyzed to determine its potential use in generating the description of the uncrawled website. This analysis may include looking at factors such as the length of a piece of text, the frequency of words in a piece of text, and the syntax of a piece of text. Additionally, characteristics of secondary sources, from which these pieces of text were derived, may be analyzed to supplement the description. These characteristics may include the language of the secondary source website, and the rate at which data on the secondary source is updated. Inferences from these characteristics may be drawn to assist in providing a more accurate description. For example, a relatively old piece of text may be given little significance because of its age and likelihood of inaccuracy.

A description of the uncrawled website is generated based on the analysis of the relevant information. This description may be generated by simply copying a piece of descriptive text, merging multiple pieces of text, or supplementing a piece of descriptive text. Thereafter, this description may be provided in a search result along with a link to the uncrawled website.

The present invention may also be applied to websites that have been previously crawled. In this embodiment, relevant information derived from at least one secondary source may be identified and analyzed to generate a description of the crawled website.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is an illustration of an embodiment of a system used to provide a description of an uncrawled website.

FIG. 2 is an illustration of an embodiment of a device used to describe an uncrawled website.

FIG. 3 is an illustration of an embodiment of a device used to analyze secondary source characteristics to assist in generating a description of an uncrawled website.

FIG. 4 is a flowchart of an embodiment for generating a user a description of an uncrawled website

FIG. 5 is a more detailed flowchart of embodiments for generating a description of an uncrawled website.

FIG. 6 is a flowchart of embodiments for generating a description of an uncrawled website based on anchor text.

### DETAILED DESCRIPTION OF THE PREFERRED EMBODIMENTS

An apparatus and method for generating a description of an uncrawled website is described. In particular, a website describer identifies relevant information, derived from secondary sources, relating to the uncrawled website and generates a description of the uncrawled website based on analysis of this relevant information. In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be incorporated in a number of different networking devices as software (e.g., software that is stored in memory or other computer readable medium), hardware or firmware. Accordingly, structures, processes, and devices shown below in block diagram are illustrative of specific embodiments of the invention and are meant to avoid obscuring the invention.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

A. System Overview

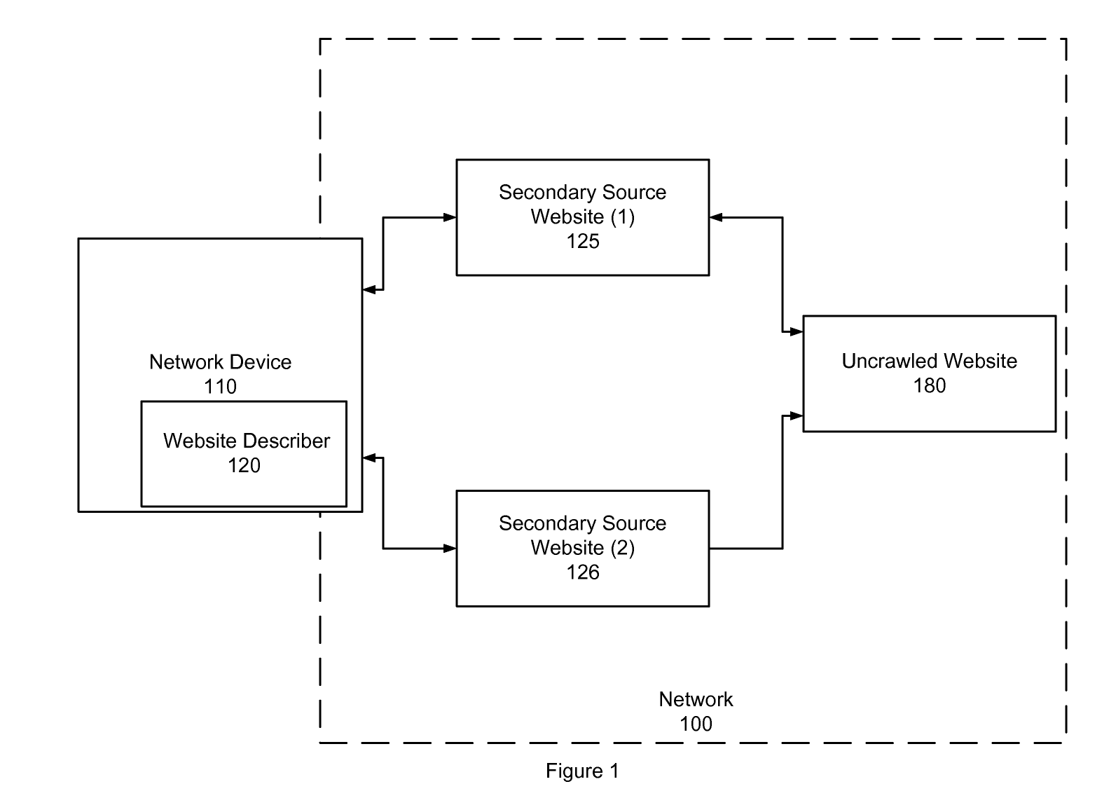

FIG. 1 illustrates an embodiment of a system that may be used to generate a description of an uncrawled website from data derived directly from a secondary source, meaning a source other than the uncrawled website. A network 100 contains a first website 125, a second website 126, an uncrawled website 180 and a network device 110. Examples of the network 100 may include small private networks, larger enterprise networks, the Internet, and combinations thereof. The first and second websites (125, 126) are examples of secondary sources from which a description of the uncrawled website 180 may be generated.

According to this embodiment, the first and second websites (125, 126), have already been crawled and data derived from these sites (125, 126) has been copied, indexed and stored. This data includes content, such as text, copied from the sites (125, 126) as well as site characteristics, such as the ages of the sites or their locations. This data (hereinafter “processed data”) contains certain information relevant to the uncrawled website 180. For example, one or both of these sites (125, 126) may contain a link pointing to the uncrawled website 180. Text associated with this link may be identified as relevant because it may describe the uncrawled website 180. Additionally, particular characteristics of the sites (125, 126) may be relevant in providing insight about the uncrawled website 180.

A website describer 120, located on the network device 110 (e.g., a server in a search engine, sometime called a search engine system), accesses this processed data, identifies relevant information within the processed data, and uses this relevant information to generate a description of the uncrawled website 180. Accordingly, the website describer 120 is able to generate a description of the uncrawled website 180 independent of any data derived directly from the uncrawled website 180.

B. Website Describer

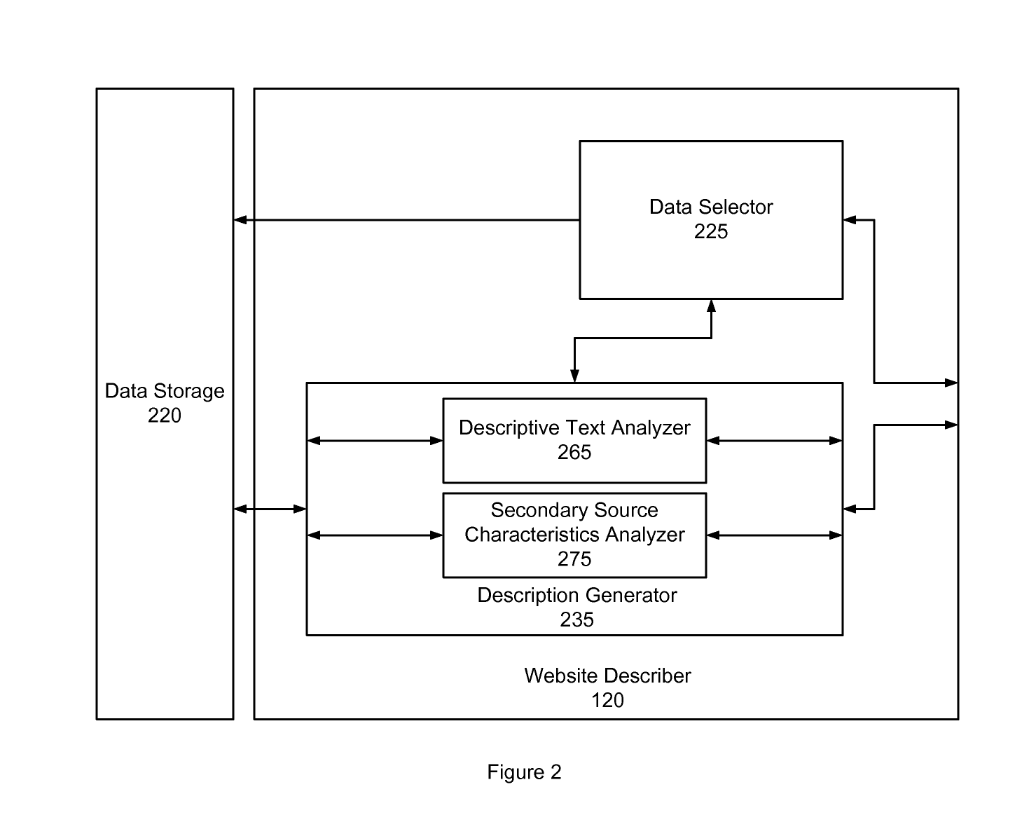

FIG. 2 illustrates an embodiment of the website describer 120. According to this particular embodiment, the website describer 120 contains a data selector 225 and a description generator 235.

1. Data Selector

The data selector 225 accesses a data storage device 220 wherein the processed data, derived from the first and second websites (125, 126), is stored. The data selector 225 identifies information, contained within the processed data, that is relevant to the uncrawled website 180. According to this embodiment, information relevant to the uncrawled website 180 (hereinafter “relevant information) is identified by selection criteria that are applied to the processed data derived from the first and second websites (125, 126). The selection criteria parse the processed data and identify relevant information therein according to associations and types of text found within this processed data. For example, anchor text, located on the first or second websites (125, 126) and relating to the uncrawled website, may be identified by the data selector 225 through its association with a link pointing to the uncrawled website. In particular, this anchor text may be parsed from the first or second websites (125, 126) according to tags within the site source code that surround the anchor text.

The data selector 225 may also identify particular characteristics of the first website 125 that are relevant to the uncrawled website 180. Inferences from these characteristics may be made that might assist is generating a more accurate description of the uncrawled website 180. Additionally, these characteristics may provide guidance in tailoring a description to a particular search query. For example, assume that the first website 125 engages in commercial activity in a particular market and the content on this site 125 has not been updated for a long period of time. These characteristics may suggest that content on the first website 125 may be stale and less reliable. Such an inference could aid in generating a more accurate description of the uncrawled website 180.

One embodiment of the data selector 225 highlights the application of a particular parameter within the selection criteria. According to this embodiment, the data selector 225 identifies relevant information by selecting anchor text associated with a link pointing to the uncrawled website 180. Anchor text is a piece of text that marks the beginning and/or the end of the link. In some implementations, the link is an HTML element called an anchor tag, which includes a URL and anchor text distinct from the URL. The URL in the anchor tag specifies the target of the link, and the anchor text, which is distinct from the URL, is typically displayed at the location of the anchor tag in the webpage or other document that includes the anchor tag). In this example, the anchor tag includes an “href” parameter (e.g., <a href=“http://www.w3schools.com”>, the value of which is the URL of the link. The anchor text of the link is the text located between the <a> tag and the corresponding </a> tag, and thus is a distinct element of the link from the URL. Anchor text is typically displayed in a manner that emphasizes the anchor text, so that a user will recognize that clicking on the anchor text causes the link to be followed. For example, anchor text may be underlined, colored, or highlighted to stand-out from other text on a website. The data selector 225 identify this anchor text as potentially relevant information because of its association with the link and its data type (i.e., anchor text).

In another embodiment, the data selector 225 identifies relevant information be selecting text according to its proximity to the link. Selection criteria may include a proximity range that identifies text within this range as relevant information. This particular criterion assumes that text, in close proximity to the link, describes the uncrawled website 180. Accordingly, the data selector 225 identifies relevant information by identifying text within a defined proximate distance from the link to the uncrawled website 180.

One skilled in the art will recognize that numerous parameters may be used to identify relevant information, both text and site characteristics, found within the processed data. Text may be identified according to its location on a website, its content, the frequency of words appearing in the text, its syntax, its relationship to a link, or numerous other parameters. Site characteristics may be identified according to a relationship to the uncrawled website 180, a relationship to other secondary sources, or relationship to the text on the site.

2. Description Generator

In one embodiment, after relevant information has been identified, the description generator 235 analyzes this relevant information and generates an appropriate description of the uncrawled website 180 based on this analysis. In particular, in one embodiment the description generator 235 analyzes the relevant information by applying parameters to each piece of relevant information to determine possible uses of the information in generating the description of the uncrawled website 180. According to embodiments of the invention shown in FIG. 2, the description generator 235 contains a text analyzer 265, a secondary source characteristics analyzer 275, or both (as shown).

a) Text Analyzer

In one embodiment, the text analyzer 265 analyzes pieces of text within the relevant information. In particular, the text analyzer 265 analyzes these pieces of text relative to various parameters indicative of text on which a description may be based. For example, these pieces of text may be analyzed according to their length, the frequency of which particular words appear in the text pieces, and their syntactic correctness. The analysis may also include methods in which the pieces of text may be copied, merged or supplemented to generate the description of the uncrawled website 180.

In one embodiment, the text analyzer 265 analyzes a first piece of anchor text from the first website 125 and a second piece of anchor text from the second website 126. This analysis may compare the frequency of words used in both pieces of anchor text and determine the most commonly used words. From these most commonly used words, the text analyzer 265 may determine various methods these words may be merged to generate an appropriate description of the uncrawled website 180.

In another embodiment, the text analyzer 265 analyzes a first piece of anchor text from the first website 125 and a second piece of anchor text from the second website 126. This analysis determines that the first piece of anchor text is a syntactically correct phrase and the second piece of anchor text is a single word. The text analyzer 265 may determine that an appropriate method to generate the description is to simply copy the first piece of anchor text and disregard the second piece of anchor text.

One skilled in the art will recognize that there are a large number of parameters applicable to analyzing text for relevance to the uncrawled website 180. Also, one skilled in the art will recognize that there are a large number of methods in which these parameters may be applied to this text.

b) Secondary Source Characteristics Analyzer

In one embodiment, the secondary source characteristics analyzer 275 analyzes attributes of a secondary source(s) to provide insight about particular aspects of the uncrawled website 180 and to further supplement the generation of the description of the uncrawled website 180. Although these secondary source attributes may not directly describe the uncrawled website 180, particular details about the uncrawled website 180 may be inferred and assist in generating a more accurate description of the uncrawled website 180.

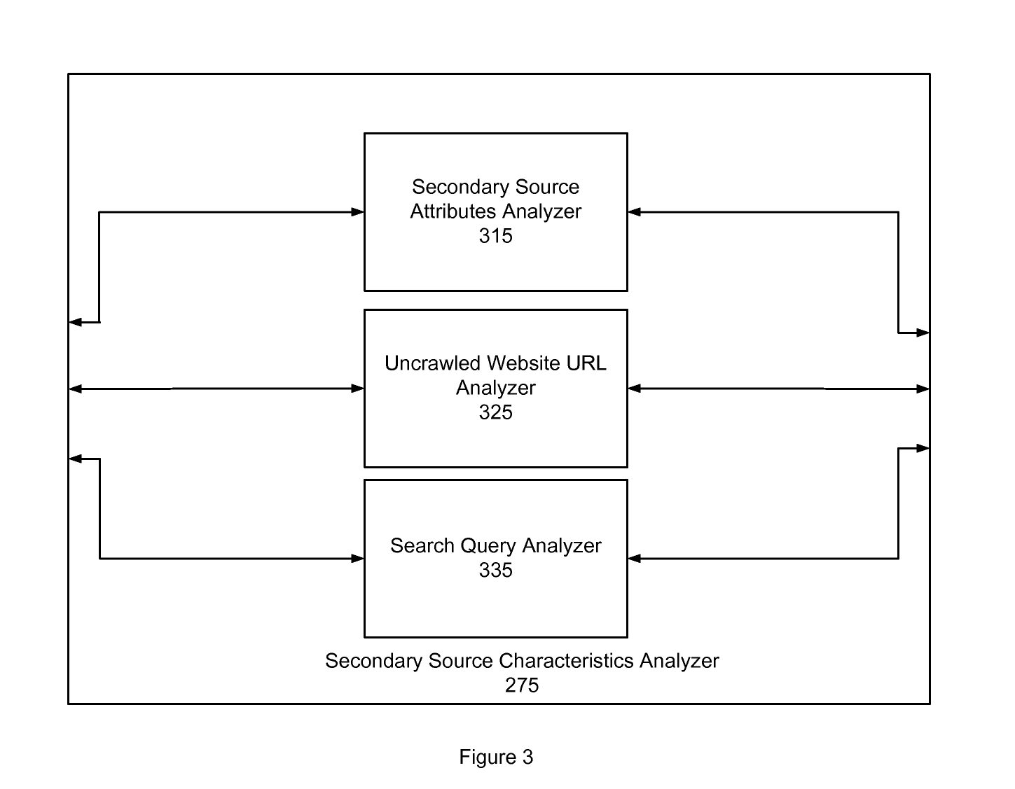

FIG. 3 illustrates embodiments of the secondary source characteristics analyzer 275. According to these embodiments, the secondary source characteristics analyzer 275 may contain a secondary source website attributes analyzer 315, an uncrawled website URL analyzer 325, a search query analyzer 335, or any combination thereof.

(i) Secondary Source Website Attributes Analyzer

The secondary source website attributes analyzer 315 analyzes relevant attributes of secondary source websites (e.g., 125, 126) from which processed data was derived. In particular, these website attributes are analyzed to determine if details about the uncrawled website 180 or data derived from the secondary source website may be appropriately inferred from particular secondary source attributes. These inferred details can then be used to aid in generating the description of the uncrawled website 180.

According to an embodiment, the secondary source website attributes analyzer 315 determines the date on which data on the first website 125 was last updated. If an update to this data has not occurred for a long period of time, then any relevant information derived from the first website 125 may be stale or incorrect. Other factors may also be analyzed including the date a website page was created or the frequency that the website is updated. Accordingly, relevant data from the first website 125 would not likely be appropriate to be used in generating the description of the uncrawled website 180.

According to another embodiment, the secondary source website attributes analyzer 315 determines the language in which content on the secondary source website is written. If a large majority of the text is written in a particular language, then an appropriate inference may be made that the text on the uncrawled website 180 is written in the same language. This inference may be strengthened if multiple secondary sources, pointing to the uncrawled website 180, also primarily contain text in this language. Accordingly, a description of the uncrawled website 180 may be appropriately written in this language that is shared among these multiple secondary sources.

According to yet another embodiment, the secondary source website attributes analyzer 315 determines a primary purpose for which the first website 125 is used. For example, the first website 125 may be a commercial website used to sell a product or may contain obscene material. This purpose may then be used to determine the significance of relevant data derived from the first website 125, including establishing if there might be any bias against the uncrawled website 180. Depending on this analysis, and a description of the uncrawled website 180 may not take into account relevant information from this first website 125.

One skilled in the art will recognize that numerous secondary source website attributes may be analyzed to gain additional insight about the uncrawled website 180 or secondary source websites from which relevant information is derived.

(ii) Uncrawled Website URL Analyzer

In one embodiment, the uncrawled website URL analyzer 325 analyzes characteristics of the URL corresponding to the uncrawled website 180. In particular, these characteristics may be analyzed to determine if details about the uncrawled website 180 may be appropriately inferred from its URL. These inferred details can then be used to aid in generating a more accurate description of the uncrawled website 180.

According to one embodiment, the domain of the URL is analyzed to determine a location of the uncrawled website 180. This location may suggest an appropriate language in which the description of the uncrawled website 180 should be generated.

According to another embodiment, words within the URL are compared to pieces of text derived from secondary sources. This comparison may help identify certain significant words in the pieces of text that may be used to generate a description of the uncrawled website 180. Accordingly, these significant words may be given more or less weight in generating the description.

(iii) Search Query Analyzer

In one embodiment, the search query analyzer 335 analyzes the search query that returned the uncrawled website 180 in order to determine details about the uncrawled website 180 or the user that may assist in generating the description of the uncrawled website 180. In particular, the search query analyzer 335 may analyze terms in this search query or characteristics of the search query that might provide insight into the uncrawled website 180 or details about the user. These particular search terms or characteristics could then be used to aid in generating the description of the uncrawled website 180.

According to an embodiment, terms within the search query are compared to pieces of relevant text derived from secondary sources. This comparison may help identify certain significant words in the pieces of text that may be used to generate a description of the uncrawled website 180. Accordingly, these significant words may be given more weight in generating the description.

According to another embodiment, characteristics of the search query are analyzed to better tailor the description to the user. For example, if the search query was written in a particular language, the description of the uncrawled website 180 may be generated in this particular language for the user.

C. Methods for Generating a Description of an Uncrawled Website

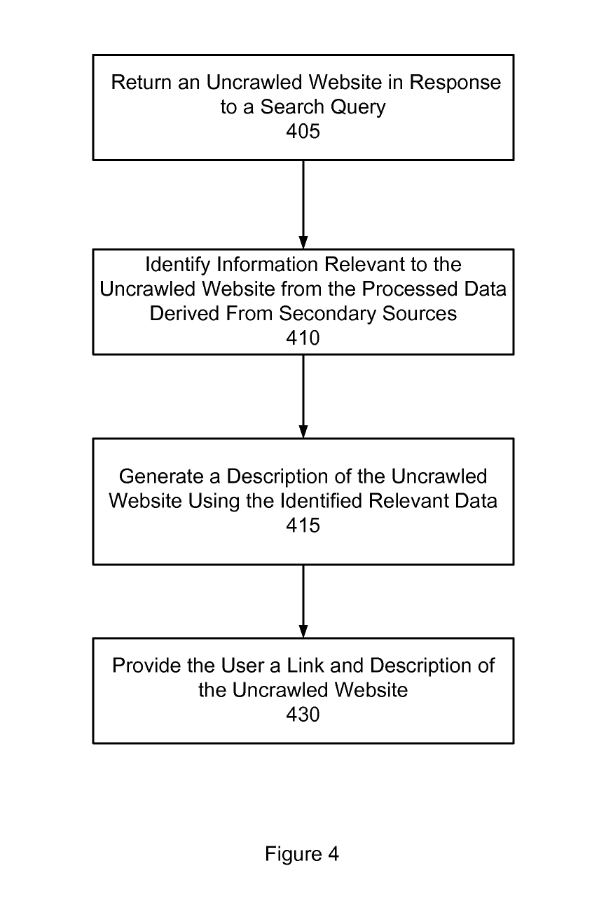

FIG. 4 illustrates a method for generating a description of an uncrawled website according to one embodiment of the present invention. As shown in this flowchart, a search query returns 405 an uncrawled website in its search results. Because this site has not been crawled, data derived from secondary sources is used to generate a description of the uncrawled website. As described above, in the Background section of this document, the context for FIG. 4 is the generation of list of search results in response to receipt of a search query from a user (e.g., at a client system or device). The list of search results, as noted above, includes for each respective search result, a link having a URL and descriptive text distinct from the URL. In some implementations, a respective search result in the list of search results is an uncrawled website. Methods for generating the descriptive text portion of this search result are described with respect to FIGS. 4, 5 and 6.

Information relevant to the uncrawled website is identified 410 within processed data derived from a secondary source(s). This relevant information is analyzed to determine an appropriate use for each piece of relevant information in generating a description of the uncrawled website.

A description of the uncrawled website is generated 415 based on the analysis of the relevant information. This description and a link to the uncrawled website are provided 430 in a search result.

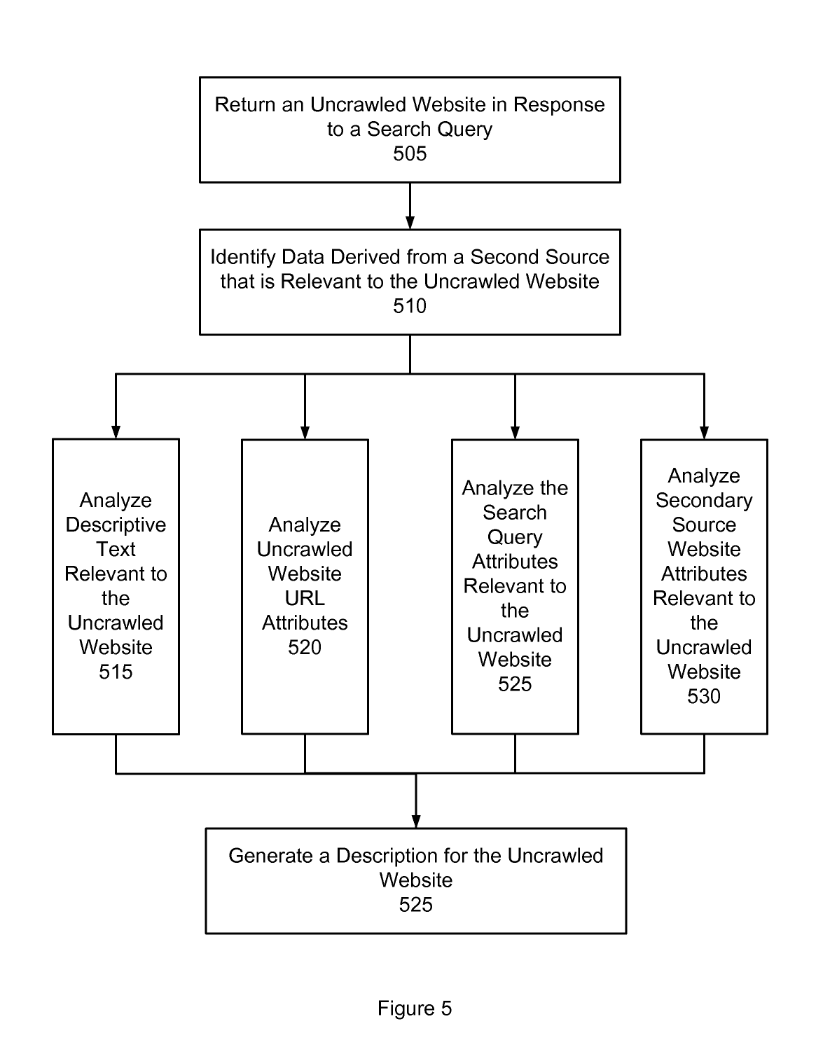

FIG. 5 illustrates methods for generating a description of the uncrawled website. As shown in this flowchart, a search query returns 505 an uncrawled website in its search results. Information relevant to the uncrawled website is identified 510 within processed data derived from a secondary source(s). This relevant information may contain descriptive text from a secondary source, attributes of a secondary source, attributes of the search query, and attributes of the uncrawled website URL.

According to an embodiment, descriptive text that is derived from a secondary source and relevant to the uncrawled website is analyzed 515. This analysis may include applying selection criteria to select significant pieces of text from which the description of the uncrawled website may be generated. As previously discussed, the selection criteria may include the location of the piece of text, the type of text, the length of text, and the syntax of the text.

According to another embodiment, secondary source website attributes relevant to the uncrawled website are analyzed 530 to gain further insight about the uncrawled website and the secondary sources. This analysis may also include applying selection criteria to select significant website attributes that may provide additional guidance in generating a more accurate description of the uncrawled website. As discussed previously, selection criteria may include the language of the secondary source, the last time the secondary source was updated, and the physical location of the secondary source.

According to yet another embodiment, search query attributes relevant to the uncrawled website are analyzed 525. This analysis uses attributes of the search query, such as search terms and the language of the search query, to assist in generating the description of the uncrawled website. As previously described, terms within the search query may be compared with the descriptive text to determine the significance of particular words found within a particular piece of descriptive text. Furthermore, the language of the search query may be used to determine a language in which the description should be generated.

According to still another embodiment, the uncrawled website URL attributes are analyzed 520. This analysis may further aid generating a description of the website. For example, words within the URL may be compared with the descriptive text to determine the significance of particular words found within a particular piece of descriptive text. Furthermore, the domain of the URL may suggest a language in which the description should be generated.

The analysis of identified relevant information may incorporate only one of the above-described analyses (i.e., 515, 520, 525 and 530) or may incorporate a combination of these analyses. Accordingly, the present invention may modify its analysis depending on the amount and type of relevant information available on the uncrawled website.

A description of the uncrawled website is generated 525 based on an analysis of the relevant information. This description may be generated by simply copying a particular piece of descriptive text, merging multiple pieces of text together, or supplementing a piece of text. This description may then be provided in a search result along with a link to the uncrawled website. This description may also be stored and later used if the uncrawled website is returned again in a search result.

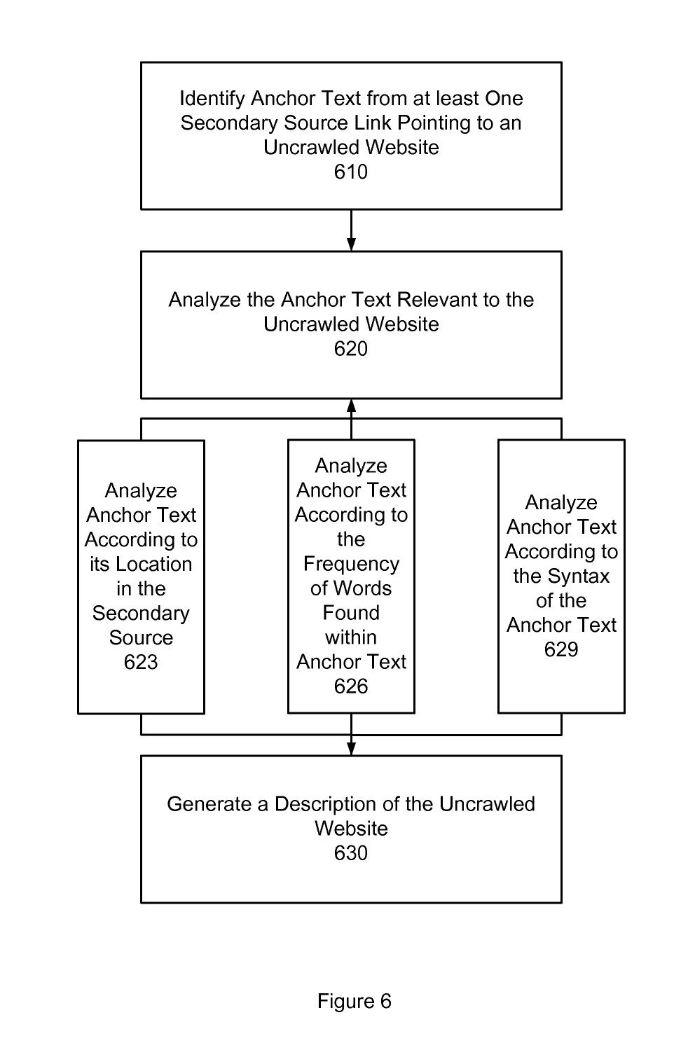

FIG. 6 is a more specific illustration of a method for generating a description of the uncrawled website according to one embodiment of the present invention. As shown in this flowchart, anchor text located on a secondary source(s) is identified and analyzed to generate an appropriate description of an uncrawled website.

Anchor text, from at least one secondary source and associated with a link to the uncrawled website, is identified as relevant to the uncrawled website. This identification may include selecting a piece of anchor text in its entirety or parsing out relevant pieces from the anchor text. Also, multiple pieces of anchor text may be identified as relevant to the uncrawled website. Each piece of anchor text is analyzed 620 to determine its potential uses in generating the description of the uncrawled website.

According to one embodiment, the anchor text is analyzed 623 according to its location on a secondary source website. For example, pieces of anchor text that appear in close proximity to each other may be considered more or less significant depending on the particular analysis.

According to another embodiment, the anchor text is analyzed 626 according to the frequency of words that appear within pieces of anchor text. Significant words may be determined by comparing words in multiple pieces of anchor text, comparing words in anchor text and secondary source characteristics, or comparing words in anchor text and search terms. The most frequently used words may be selected as words on which the description of the uncrawled website should be generated.

According to yet another embodiment, the anchor text is analyzed 629 according to the syntactic correctness of the piece of anchor text. Pieces of anchor text with correct syntax may be selected as more significant. These syntactically correct pieces of anchor text may be copied or modified slightly to generate a description of the uncrawled website while other pieces of anchor text having incorrect syntax may be disregarded.

A description of the uncrawled website is generated 630 based on one or more of the above-described anchor text analyses. This description may be generated by simply copying a piece of anchor text, merging multiple pieces of anchor text together or supplementing anchor text with other words. Thereafter, this description may be provided in a search result along with a link to the uncrawled website. Furthermore, this description may be stored in a storage device if the uncrawled website is returned in another search result.

The present invention may also be similarly applied to websites that have been previously crawled. According to this embodiment, anchor text derived from a secondary source is identified as relevant to a particular crawled website. This anchor text is analyzed to select appropriate piece(s) of anchor text from which a description of the crawled website may be generated. Based on this analysis, a description of the crawled website is generated.

The present invention may also be applied to a stored document, such as a locally stored website or document linked within a document management system, to which a secondary source refers. Similarly to the methods and devices described above, information from a secondary source may be identified as relevant to this stored document, thereafter analyzed and, based on this analysis, a description of the document may be generated.

While the present invention has been described with reference to certain embodiments, those skilled in the art will recognize that various modifications may be provided. For example, numerous types of analyses and steps may be performed in order to identify relevant data and its significance so that an appropriate website description may be generated. Variations upon and modifications to the embodiments are provided for by the present invention, which is limited only by the following claims.

What is claimed is:

1. A computer-implemented method, performed by a search engine system, the method comprising:
receiving a search query from a user;
generating a list of search results, the list including for each respective search result, a link having a URL and descriptive text distinct from the URL; wherein a respective search result in the list of search results comprises a respective link having a respective URL and respective descriptive text distinct from the respective URL;
the generating including, for the respective search result in the list of search results:
identifying anchor text in one or more links to the respective URL, wherein the one or more links to the respective URL are contained in content of at least one source website and the identified anchor text is distinct from the respective URL;
generating the descriptive text of the respective search result, comprising a user-readable description of a website corresponding to the respective URL, based on analysis of the identified anchor text;
providing to the user at least a portion of the list of search results, including the respective search result having the descriptive text generated based on analysis of the identified anchor text.

2. The method of claim 1, wherein the respective search result includes a link to an uncrawled website and descriptive text describing the uncrawled website, the descriptive text based on analysis of anchor text in one or more links to the uncrawled website, the one or more links located in content of the at least one source website, each of which is distinct from the uncrawled website.

3. The method of claim 1, further comprising identifying the anchor text based on selection criteria indicative of text that is appropriate for generating a description of the website.

4. The method of claim 3, wherein the analysis of the identified anchor text includes analysis of the identified anchor text according to its location on the at least one source website.

5. The method of claim 3, wherein the analysis of the identified anchor text includes analysis according to the appearance of particular words within the identified anchor text.

6. The method of claim 3, wherein the analysis of the identified anchor text includes analysis according to the syntax of the identified anchor text.

7. The method of claim 1, wherein the at least one source website is distinct from a website corresponding to the respective URL.

8. A system for generating a description of a website, comprising:
memory;
one or more processors coupled to the memory; and
one or more programs stored in the memory, which when executed by the one or more processors cause the system to:
generate a list of search results, the list including for each respective search result, a link having a URL and descriptive text distinct from the URL; wherein a respective search result in the list of search results comprises a respective link having a respective URL and respective descriptive text distinct from the respective URL;
wherein generating the list of search results includes, for the respective search result in the list of search results:
identifying anchor text in one or more links to the respective URL, wherein the one or more links to the respective URL are contained in content of at least one source website and the identified anchor text is distinct from the respective URL;
generating the descriptive text of the respective search result, comprising a user-readable description of a website corresponding to the respective URL, based on analysis of the identified anchor text; and
provide to the user at least a portion of the list of search results, including the respective search result having the descriptive text generated based on analysis of the identified anchor text.

9. The system of claim 8, wherein the respective search result includes a link to an uncrawled website and descriptive text describing the uncrawled website, the descriptive text based on analysis of anchor text in one or more links to the uncrawled website, the one or more links located in content of the at least one source website, each of which is distinct from the uncrawled website.

10. The system of claim 8, the one or more programs further comprising instructions for identifying the anchor text based on selection criteria indicative of text that is appropriate for generating a description of the website.

11. The system of claim 10, wherein the analysis of the identified anchor text includes analysis of the identified anchor text according to its location on the at least one source website.

12. The system of claim 10, wherein the analysis of the identified anchor text includes analysis according to the appearance of particular words within the identified anchor text.

13. The system of claim 10, wherein the analysis of the identified anchor text includes analysis according to the syntax of the identified anchor text.

14. The system of claim 8, wherein the at least one source website is distinct from a website corresponding to the respective URL.
